(19) United States
(12) Patent Application Publication
(10) Pub. No.: US 2014/0332327 A1
(43) Pub. Date: Nov. 13, 2014

(54) BRAKE APPARATUS FOR VEHICLE

(71) Applicant: HYUNDAI MOBIS CO., LTD., Seoul (KR)

(72) Inventor: JONG SUNG KIM, Seoul (KR)

(73) Assignee: HYUNDAI MOBIS CO., LTD., Seoul (KR)

(21) Appl. No.: 14/088,273

(22) Filed: Nov. 22, 2013

(30) Foreign Application Priority Data
May 9, 2013 (KR) 10-2013-0052775

(51) Int. Cl. F16D 65/58

(52) U.S. Cl. CPC F16D 65/58
USPC 188/72.3

(57) ABSTRACT

A brake apparatus for a vehicle includes: a wedge unit connected to a brake pad; a driving device coupled to the wedge unit so as to pressurize the wedge unit toward a brake disk; a piston supported by a caliper body and having a hydraulic chamber formed therein; a housing movably coupled to the piston, connected to the wedge unit, and moving the wedge unit toward the brake disk when oil is supplied to the hydraulic chamber; a sealing member disposed between an outer surface of the piston and an inner surface of the housing; and an elastic member disposed in the hydraulic chamber and pressurizing the housing toward the brake disk.

### CROSS-REFERENCES TO RELATED APPLICATIONS

The present application claims priority to Korean application number 10-2013-0052775, filed on May 9, 2013 which is incorporated by reference in its entirety.

### BACKGROUND OF THE INVENTION

The present invention relates to a brake apparatus for a vehicle, and more particularly, to a brake apparatus for a vehicle, which is capable of constantly maintaining an interval between a brake disk and a brake pad.

In general, a vehicle includes a brake apparatus installed to brake the vehicle. The brake apparatus may include an electronic wedge brake.

The electronic wedge brake has a wedge unit including a brake wedge, a base wedge, and a roller. The brake wedge is moved toward a brake disk by a motor. As a brake pad of the brake wedge is rubbed against the brake disk, the vehicle is braked.

Furthermore, the wedge unit is connected to a hydraulic actuator. The hydraulic actuator includes a housing and a piston. The housing has the piston installed therein, the piston is connected to a hydraulic line, and the hydraulic line has a valve installed therein. Between the inner surface of the housing and the outer surface of the piston, a sealing member is disposed. When the valve is opened, brake oil is supplied to a hydraulic chamber, and the housing is moved toward the brake disk by oil pressure. As the housing is moved, the wedge unit is moved to come in contact with the brake disk.

The related art of the present invention is disclosed in Korean Patent Laid-open Publication No. 2010-0041953 published on Apr. 23, 2010 and entitled “Single motor-type electronic wedge brake apparatus”.

As oil is supplied to the piston, the housing is moved toward the brake pad. At this time, since the oil pressure in the piston continuously increases, the sealing member is deformed. Before the valve of the hydraulic line is opened after the braking process is completed, the deformed state of the sealing member is maintained. Thus, the pressure of the sealing member to pressurize the piston remains. When the valve is opened, the housing is moved toward the opposite side of the brake disk by the restoring force of the sealing member. Thus, the interval between the brake disk and the brake pad may be increased to reduce the braking performance. Therefore, there is a demand for a structure capable of solving such a problem.

### SUMMARY OF THE INVENTION

Embodiments of the present invention are directed to a brake apparatus for a vehicle, which is capable of constantly maintaining the interval between the brake disk and the brake pad.

In one embodiment, a brake apparatus for a vehicle includes: a wedge unit connected to a brake pad; a driving device coupled to the wedge unit so as to pressurize the wedge unit toward a brake disk; a piston supported by a caliper body and having a hydraulic chamber formed therein; a housing movably coupled to the piston, connected to the wedge unit, and moving the wedge unit toward the brake disk when oil is supplied to the hydraulic chamber; a sealing member disposed between an outer surface of the piston and an inner surface of the housing; and an elastic member disposed in the hydraulic chamber and pressurizing the housing toward the brake disk.

The elastic member may be disposed to come in contact with the inner surface of the hydraulic chamber.

The brake apparatus may further include a length restriction unit disposed in the hydraulic chamber so as to restrict the extended length of the elastic member.

The length restriction unit may include: a fixed boss fixed to the housing or the piston and disposed in the elastic member; a moving rod movably installed in the fixed boss; and a stopper substantially preventing the moving rod from coming off from the fixed boss by the elastic member.

The stopper may include: a hook connected to the fixed boss and protruding toward the internal center of the fixed boss; and a locking bump formed on the outer surface of the moving rod so as to restrict the hook.

The moving rod may include: a support plate supported by one end of the elastic member; an extension extended from the support plate; and an expansion formed to be stepped from the extension and forming the locking bump to which the hook is locked.

The expansion may have a guide groove through which the hook passes when the expansion is inserted into the fixed boss, and the guide groove may be formed in parallel to the longitudinal direction of the moving rod.

A housing groove may be formed on the inner surface of the housing or the outer surface of the piston so as to house the sealing member.

A corner of the housing groove at the opposite side of the brake disk may form a right angle, and another corner of the housing groove at the side of the brake disk may form an inclined angle.

The housing may have a protrusion formed to face the hydraulic chamber of the piston.

The brake apparatus may further include a restriction ring disposed between the circumferential surface of the protrusion and the inner surface of the piston.

The driving device may include: a wedge link connected to a brake wedge of the wedge unit so as to obliquely move the brake wedge; and a motor moving the wedge link.

### BRIEF DESCRIPTION OF THE DRAWINGS

FIG. 1 is a configuration diagram illustrating a state in which a brake apparatus for a vehicle in accordance with an embodiment of the present invention is connected through a hydraulic line.

FIG. 2 is a perspective view of the brake apparatus of FIG. 1.

FIG. 3 is a diagram schematically illustrating the brake apparatus for a vehicle in accordance with a first embodiment of the present invention.

FIG. 4 is a cross-sectional view of the brake apparatus of FIG. 3.

FIG. 5 is a cross-sectional view of the brake apparatus of FIG. 4, illustrating the sealing member and a housing groove.

FIG. 6 is a cross-sectional view of a brake apparatus for a vehicle in accordance with a second embodiment of the present invention.

FIG. 7 is a perspective view of a length restriction unit in the brake apparatus of FIG. 6.

FIG. 8 is an exploded perspective view of the length restriction unit of FIG. 7.

FIG. 9 is a cross-sectional view of a brake apparatus for a vehicle in accordance with a third embodiment of the present invention.

### DESCRIPTION OF SPECIFIC EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

Hereafter, a brake apparatus for a vehicle in accordance with a first embodiment of the present invention will be described with reference to the accompanying drawings.

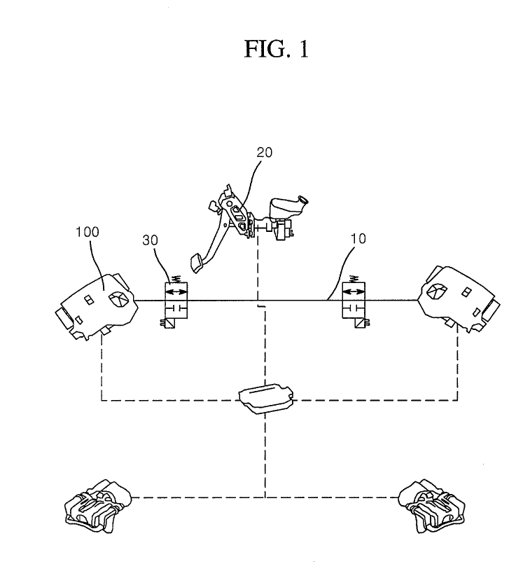

FIG. 1 is a configuration diagram illustrating a state in which a brake apparatus for a vehicle in accordance with an embodiment of the present invention is connected through a hydraulic line.

Referring to FIG. 1, the brake apparatus 100 is connected to a hydraulic line 10, and the hydraulic line 10 is connected to a brake pedal 20. The hydraulic line 10 may have a valve 30 installed to supply brake oil or block the supply of brake oil. The valve 30 may include a solenoid valve which is electronically opened and closed.

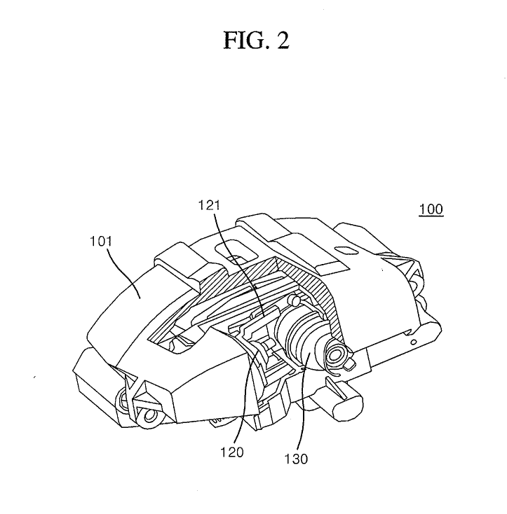

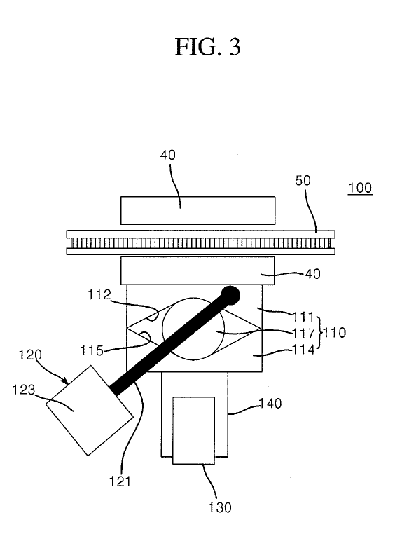

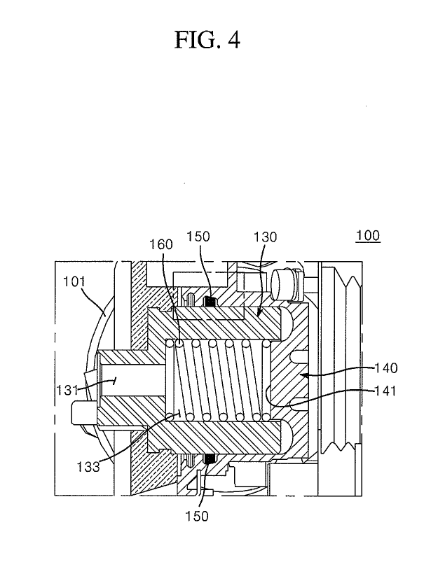

FIG. 2 is a perspective view of the brake apparatus of FIG. 1. FIG. 3 is a diagram schematically illustrating the brake apparatus for a vehicle in accordance with a first embodiment of the present invention. FIG. 4 is a cross-sectional view of the brake apparatus of FIG. 3.

Referring to FIGS. 2 to 4, the brake apparatus 100 for a vehicle includes a wedge unit 110, a driving device 120, a piston 130, a housing 140, a sealing member 150, and an elastic member 160.

Outside the brake apparatus 100, a caliper body 101 is installed. The caliper body 101 is installed to surround the wedge unit 110, the driving device 120, the piston 130, the housing 140 and the like. The driving device 120 and the piston 130 may be supported by the caliper body 101.

The wedge unit 110 is disposed at one side of the brake disk 50. The wedge unit 110 includes a brake wedge 111, a base wedge 114, and a roller 117.

The brake wedge 111 is coupled to a brake pad 40, and the base wedge 114 is disposed to correspond to the brake wedge 111. The brake wedge 111 and the base wedge 114 include inclined grooves 112 and 115 formed on surfaces thereof facing each other, respectively, and the roller 117 is installed in the inclined grooves 112 and 115 so as to be contacted with the brake wedge 111 and the base wedge 114. FIG. 3 illustrates a structure in which each of the brake wedge 111 and the base wedge 114 has one inclined groove formed therein. However, each of the brake wedge 111 and the base wedge 114 has two or more inclined grooves formed therein, and one roller 117 may be disposed in each of the inclined grooves. The wedge unit 110 may be formed with a variety of structures.

The driving device 120 is coupled to the wedge unit 110 so as to pressurize the wedge unit 110 toward the brake disk 50. The driving device 120 includes a wedge link 121 connected to the brake wedge 111 of the wedge unit 110 and a motor 123 to move the wedge link 121.

The wedge link 121 is obliquely connected to the brake wedge 111, and obliquely moves the brake wedge 111. As the brake wedge 111 is obliquely moved while coming in rolling contact with the roller 117, the brake wedge 111 may increase the pressurizing force of the wedge unit 110. Thus, although the motor 123 having a relatively small capacity is used, a sufficient braking force may be obtained.

The piston 130 is supported by the caliper body 101. The piston 130 has a hydraulic chamber 133 formed therein. The piston 130 has an introduction port 131 connected to the hydraulic chamber 133, and the introduction port 131 is connected to the hydraulic line 10. The piston 130 is formed in such a shape that the opposite side of the introduction port 131 is opened.

The housing 140 is movably coupled to the piston 130. The housing 140 is connected to the wedge unit 110. At this time, the base wedge 114 of the wedge unit 110 is connected to the housing 140.

The housing 140 is formed to surround the outer surface of the piston 130 and an opening of the piston 130. The housing 140 has a protrusion 141 formed on the inner surface thereof so as to be inserted into the opening of the piston 130.

As brake oil is supplied to the piston 130, the housing 140 is moved toward the brake disk 50. As the housing 140 is moved, the wedge unit 110 is moved toward the brake disk 50. At this time, the brake pad 40 attached to the brake wedge 111 comes in contact with the brake disk 50.

The sealing member 150 is disposed between the outer surface of the piston 130 and the inner surface of the housing 140. The sealing member 150 serves to substantially prevent the brake oil supplied to the hydraulic chamber 133 from leaking to a gap between the outer surface of the piston 130 and the inner surface of the housing 140.

The elastic member 160 is disposed in the hydraulic chamber 133. The elastic member 160 is installed to pressurize the housing 140 toward the brake disk 50. The elastic member 160 may be formed in the shape of a coil spring.

The elastic member 160 may be disposed to be contacted with the inner surface of the hydraulic chamber 133. Since the elastic member 160 is installed to be contacted with the inner surface of the hydraulic chamber 133, it is possible to reduce noise caused by contact between the elastic member 160 and the piston 130 when the brake oil is supplied to the hydraulic chamber 133. Furthermore, since the elastic member 160 is stably supported, the elastic force of the elastic member 160 may be uniformly applied to the housing 140.

The brake pad 40 is worn by friction with the brake disk 50. When the brake pad 40 is worn, the relative position between the piston 130 and the housing 140 is changed, and thus a compressed length of the piston 130 is changed. That is, when the brake pad 40 is worn, the moving distance of the housing increases, and thus the compressed length of the piston 130 inevitably increases.

In order to compensate for the change, a spring constant of the elastic member 160 is set to such a value as to offset the pressurizing force applied to the piston 130 by the deformed sealing member 150. For example, when two brake pads 40 are designed to have a wear amount of 20 mm, the elastic member 160 may be designed to have a spring constant of 0.5 kgf/mm or less. According to the maximum wear amount of the brake pad 40, the spring constant of the elastic member 160 may be changed. Furthermore, the elastic member may be installed to pressurize the housing at a force of about 4 to 10 kgf.

Since the elastic member 160 applies an elastic force to push the housing 140 toward the brake disk 50, it is possible to substantially prevent the change in relative position between the piston 130 and the housing 140.

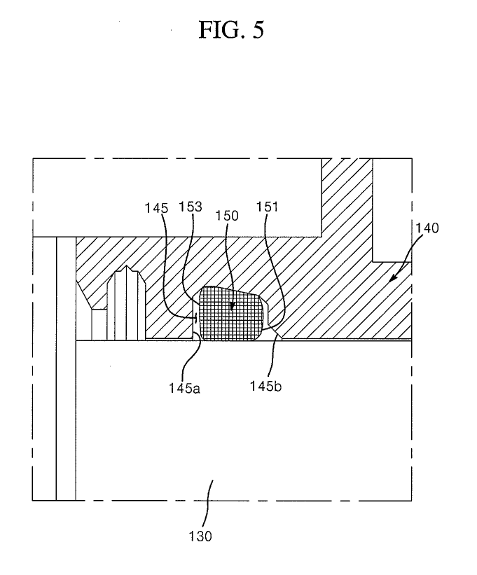

FIG. 5 is a cross-sectional view of the brake apparatus of FIG. 4, illustrating the sealing member and a housing groove.

Referring to FIG. 5, a housing groove 145 is formed on the inner surface of the housing 140 or the outer surface of the piston 130 so as to house the sealing member 150. The housing groove 145 may have a width which is larger by 0.3 mm or less than that of the sealing member 150.

The corner 145a of the housing groove 145 at the opposite side of the brake disk 50, that is, the left corner of the housing groove 145 in FIG. 5 may form a right angle, and the corner 145b of the housing groove 145 at the side of the brake disk 50, that is, the right corner of the housing groove 145 in FIG. 5 may form an inclined angle. In other words, one surface of the housing groove 145 at the opposite side of the brake disk 50 is formed perpendicular to the outer surface of the piston 130, and another surface of the housing groove 145 at the side of the brake disk 50 is formed to be inclined with respect to the outer surface of the piston 130.

One surface of the sealing member 150 at the side of the brake disk 50 is a pressure surface 151 to which the pressure of brake oil is applied, and another surface of the sealing member 150 at the opposite side of the brake disk 50 is a suction surface 153 to which the pressure of brake oil is not applied.

Since the corner 145a of the housing groove 145 at the opposite side of the brake disk 50 forms a right angle, the suction surface 153 is closely attached with the rectangular corner even though the oil pressure in the hydraulic chamber 133 of the piston 130 continuously increases.

Thus, as the deformation space of the sealing member 150 is minimized, the deformation of the sealing member 150 may be minimized. Since the deformation of the sealing member 150 may be minimized even though the pressure of the brake oil in the hydraulic chamber 133 of the piston 130 continuously increases, the restoring force of the sealing member 150 to pressurize the piston 130 may be minimized.

As a result, when the valve 30 is opened after the braking process is completed, it is possible to minimize or substantially prevent the change in relative change between the piston 130 and the housing 140 by the restoring force of the deformed sealing member 150. Furthermore, it is possible to substantially prevent the increase in interval between the brake disk 50 and the brake pad 40.

The operation of the brake apparatus for a vehicle in accordance with the first embodiment of the present invention will be described as follows.

When the brake pedal 20 of the vehicle is stepped on, the valve 30 is opened. The brake oil is introduced to the hydraulic chamber 133 of the piston 130 through the introduction port 131 of the piston 130. As the pressure of the hydraulic chamber 133 increases, the housing 140 is moved toward the brake disk 50. As the housing 140 is moved, the wedge unit 110 is moved toward the brake disk 50. When the brake pad 40 attached to the brake wedge 111 reaches the brake disk 50, the valve 30 is closed.

When the valve 30 is closed, the supply of the brake oil to the hydraulic chamber 133 of the piston 130 is stopped. Since the housing 140 is moved toward the brake disk 50 by the oil pressure, the gap between the brake pad 40 and the brake disk 50 may be compensated for, even though the brake pad 40 is worn.

As the motor 123 is driven, the wedge link 121 is moved toward the brake disk 50. The brake wedge 111 is moved toward the brake disk 50 by the wedge link 121. When the motor 123 pressurizes the brake wedge 111 through the wedge link 121, the vehicle is braked by the friction between the brake disk 50 and the brake pad 40. Since the brake wedge 111 is obliquely moved while coming in rolling contact with the roller 117, the pressurizing force of the wedge unit 110 may be increased. Thus, although the motor 123 having a relatively small capacity is used, a sufficient braking force may be obtained.

When the valve 30 is closed to stop the supply of brake oil to the hydraulic chamber 133 of the piston 130, the brake oil is continuously introduced into the hydraulic pressure 133 of the piston 130 until the pressure of the brake oil between the hydraulic line 10 and the hydraulic chamber 133 is balanced. In this case, the pressure of the hydraulic chamber 133 continuously increases. At this time, since the brake oil is moved between the outer surface of the piston 130 and the inner surface of the housing 140, almost the same pressure as the hydraulic chamber 133 may be applied to the pressure surface 151 of the sealing member 150.

Since the pressure applied to the pressure surface 151 of the sealing member 150 continuously increases, the sealing member 150 is pressurized toward the suction surface 153. At this time, the suction surface 153 of the sealing member 150 is closely attached to one surface of the corner 145a of the housing groove 145 at the opposite side of the brake disk 50, the deformation of the sealing member 150 may be minimized. That is, as the sealing member 150 is deformed, it is possible to substantially prevent residual stress from remaining in the sealing member 150.

Thus, since the restoring force of the deformed sealing member 150 may also be minimized after the braking process is completed, the restoring force of the sealing member 150 may be substantially prevented from becoming larger than the elastic force of the elastic member 160. Furthermore, it is possible to substantially prevent the change in relative position between the piston 130 and the housing 140 by the restoring force of the sealing member 150 or the residual stress.

When the braking process is completed, the valve 30 is opened. As the valve 30 is opened, the brake oil introduced into the hydraulic chamber 133 of the piston 130 is recovered through a fluid line. As the pressure of the hydraulic pressure 133 decreases, the housing 140 is moved toward the opposite side of the brake disk 50.

At this time, since the deformation of the sealing member 150 was minimized, the pressurizing force applied to the piston 130 by the sealing member 150 decreases. Furthermore, the housing 140 is pressurized toward the brake disk 50 by the elastic member 160.

Thus, since the restoring force of the sealing member 150 is offset by the restoring force of the elastic member 160, the change in relative position between the housing 140 and the piston 130 may be substantially prevented, and the degradation in braking performance of the brake apparatus 100 may be substantially prevented.

Now, a brake apparatus for a vehicle in accordance with a second embodiment of the present invention will be described. The second embodiment is substantially the same as the first embodiment, except for a length restriction unit. Thus, the following descriptions will be focused on the length restriction unit.

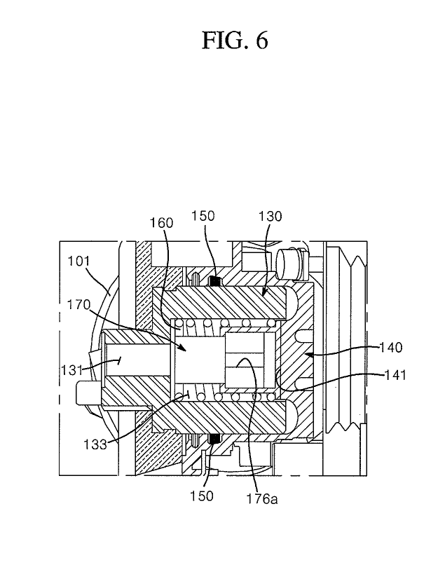

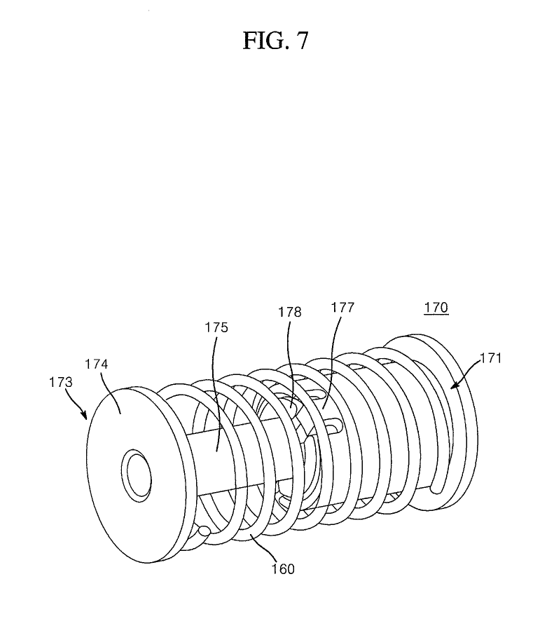

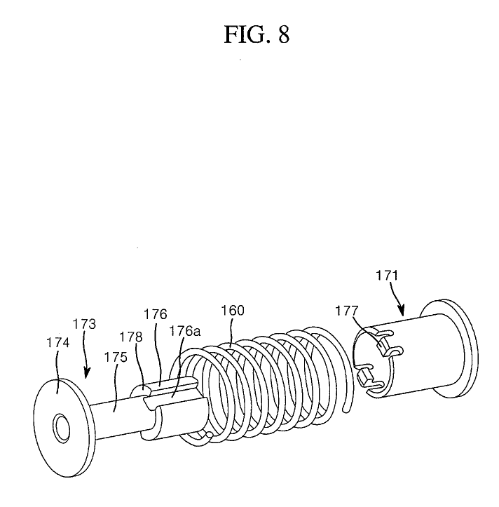

FIG. 6 is a cross-sectional view of a brake apparatus for a vehicle in accordance with a second embodiment of the present invention. FIG. 7 is a perspective view of a length restriction unit in the brake apparatus of FIG. 6. FIG. 8 is an exploded perspective view of the length restriction unit of FIG. 7.

Referring to FIGS. 6 to 8, the brake apparatus further includes a length restriction unit 170 disposed in the hydraulic chamber 133 so as to restrict the extended length of the elastic member 160. The length restriction unit 170 is inserted into the elastic member 160.

Since the elastic member 160 is extended only within a predetermined range by the length restriction unit 170, the length restriction unit 170 may restrict the extended length of the elastic member 160 in a state where the piston 130 and the housing 140 are assembled to each other. Thus, the piston 130 may be substantially prevented from deviating from the sealing member 150 due to the elastic force of the elastic member 160. Furthermore, the leakage of brake oil between the outer surface of the piston 130 and the internal surface of the housing 140 may be substantially prevented.

The length restriction unit 170 includes a fixed boss 171, a moving rod 173, and stoppers 177 and 178.

The fixed boss 171 is fixed to the housing 140 or the piston 130, and disposed in the elastic member 160. FIG. 6 illustrates a structure in which the fixed boss 171 is fixed to the housing 140, but the present invention is not limited thereto. The fixed boss 171 may be formed in a cylindrical shape as a whole.

The moving rod 173 is movably installed in the fixed boss 171. The moving rod 173 may be moved while sliding on the inner surface of the fixed boss 171. The moving rod 173 may be formed in a cylindrical shape as a whole.

The stoppers 177 and 178 serve to substantially prevent the moving rod 173 from coming off from the fixed boss 171 due to the tensile force of the elastic member 160. Furthermore, the stoppers 177 and 178 substantially prevent the moving rod 173 from being moved further than the extended length of the elastic member 160 in the fixed boss 171.

The stoppers 177 and 178 include a hook 177 connected to the fixed boss 171 and protruding toward the internal center of the fixed boss 171 and a locking bump 178 formed on the outer surface of the moving rod 173 so as to restrict the hook 177. At this time, two or more hooks 177 may be installed on the fixed boss 171 so as to face each other.

The moving rod 173 includes a support plate 174 supported by one end of the elastic member 160, an extension 175 extended from the support plate 174, and an expansion 176 formed to be stepped from the extension 175.

The expansion 176 formed to be stepped from the extension 175 forms the locking bump 178 to which the hook 177 is locked. The expansion 176 is inserted into the fixed boss 171. The expansion 176 has a guide groove 176a formed therein, through which the hook 177 passes when the expansion 176 is inserted into the fixed boss 171. The guide groove 176a is formed in parallel to the longitudinal direction of the moving rod 173.

The operation of the brake apparatus for a vehicle in accordance with the second embodiment of the present invention will be described as follows.

The elastic member 160 is inserted into the fixed boss 171, and the moving rod 173 is inserted into the elastic member 160 and the fixed boss 171. At this time, the hook 177 is slid along the guide groove 175a of the moving rod 173. When the hook 177 reaches the locking bump 178, the moving rod 173 is rotated to lock the hook 177 to the locking bump 178.

At this time, as the coupling length between the moving rod 173 and the fixed boss 171 is restricted, the extended length of the elastic member 160 is restricted. Furthermore, when the moving rod 173 is pressurized, the moving rod 173 is inserted into the fixed boss 171 so as to reduce the length of the elastic member 160. Thus, as the moving rod 173 and the fixed boss 171 are relatively moved, the elastic member 160 may be extended and contracted within a limited range.

Since the elastic member 160 applies an elastic force to push the moving rod 173 and the fixed boss 171 toward the opposite sides thereof, the moving rod 173 and the fixed boss 171 may be stably coupled to each other.

Since the extended length of the elastic member 160 is limited, the piston 130 may be are relatively moved prevented from being separated from the housing 140 when the piston 130 and the housing 140 are assembled to each other. Therefore, the leakage of the brake oil may be substantially prevented.

Now, a brake apparatus for a vehicle in accordance with a third embodiment of the present invention will be described. The third embodiment is substantially the same as the first embodiment, except for a restriction ring. Thus, the following descriptions will be focused on the restriction ring.

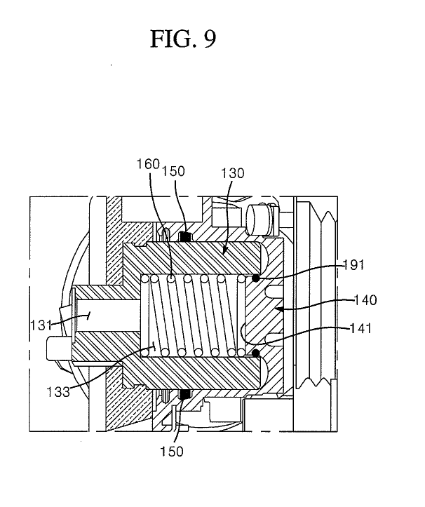

FIG. 9 is a cross-sectional view of a brake apparatus for a vehicle in accordance with a third embodiment of the present invention.

Referring to FIG. 9, the housing 140 has a protrusion 141 formed to face the hydraulic chamber 133 of the piston 130. The protrusion 141 may have a length to be slightly inserted into the hydraulic chamber 133 of the piston 130. The protrusion 141 may be formed in a circular plate shape to correspond to the hydraulic chamber 133 of the piston 130.

The brake apparatus 100 further includes a restriction ring 191 disposed between the circumferential surface of the protrusion 141 and the inner surface of the piston 130. At this time, the protrusion 141 may have a restriction groove into which the restriction ring 191 is inserted. The restriction ring 191 may include an O-ring.

The restriction ring 191 is tightly attached between the end of the inner surface of the piston 130 and the circumferential surface of the protrusion 141, the restriction ring 191 maintains a state in which the protrusion 141 is fitted into the piston 130 when the piston 130 is assembled to the housing 140. Thus, it is possible to substantially prevent the piston 130 from coming off from the housing 140 due to the expansive force of the elastic member 160.

The restriction ring 191 is positioned outside the section in which the piston 130 and the housing 140 are relatively moved when the brake apparatus 100 is operated. The restriction ring 191 holds the piston 130 only when the piston 130 is assembled to the housing 140 and then carried. When the brake pedal 20 is initially stepped on after the brake apparatus 100 is mounted in the vehicle, the piston 130 escapes from the restriction ring 191 while the piston 130 and the housing 140 are relatively moved. Thus, although the brake pedal 20 is stepped on again, the restriction ring 191 does not interfere with the piston 130. The restriction ring 191 does not disturb the braking operation when a braking force is generated.

In accordance with the embodiments of the present invention, since the interval between the brake disk and the brake pad may be constantly maintained, it is possible to improve the braking performance of the vehicle.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A brake apparatus for a vehicle, comprising:
a wedge unit connected to a brake pad;
a driving device coupled to the wedge unit so as to pressurize the wedge unit toward a brake disk;
a piston supported by a caliper body and having a hydraulic chamber formed therein;
a housing movably coupled to the piston, connected to the wedge unit, and moving the wedge unit toward the brake disk when oil is supplied to the hydraulic chamber;
a sealing member disposed between an outer surface of the piston and an inner surface of the housing; and
an elastic member disposed in the hydraulic chamber and pressurizing the housing toward the brake disk.

2. The brake apparatus of claim 1, wherein the elastic member is disposed to come in contact with the inner surface of the hydraulic chamber.

3. The brake apparatus of claim 1, further comprising a length restriction unit disposed in the hydraulic chamber so as to restrict the extended length of the elastic member.

4. The brake apparatus of claim 3, wherein the length restriction unit comprises:
a fixed boss fixed to the housing or the piston and disposed in the elastic member;
a moving rod movably installed in the fixed boss; and
a stopper substantially preventing the moving rod from coming off from the fixed boss by the elastic member.

5. The brake apparatus of claim 4, wherein the stopper comprises:
a hook connected to the fixed boss and protruding toward the internal center of the fixed boss; and
a locking bump formed on the outer surface of the moving rod so as to restrict the hook.

6. The brake apparatus of claim 5, wherein the moving rod comprises:
a support plate supported by one end of the elastic member;
an extension extended from the support plate; and
an expansion formed to be stepped from the extension and forming the locking bump to which the hook is locked.

7. The brake apparatus of claim 6, wherein the expansion has a guide groove through which the hook passes when the expansion is inserted into the fixed boss, and
the guide groove is formed in parallel to the longitudinal direction of the moving rod.

8. The brake apparatus of claim 1, wherein a housing groove is formed on the inner surface of the housing or the outer surface of the piston so as to house the sealing member.

9. The brake apparatus of claim 8, wherein a corner of the housing groove at the opposite side of the brake disk forms a right angle, and another corner of the housing groove at the side of the brake disk forms an inclined angle.

10. The brake apparatus of claim 1, wherein the housing has a protrusion formed to face the hydraulic chamber of the piston.

11. The brake apparatus of claim 10, further comprising a restriction ring disposed between the circumferential surface of the protrusion and the inner surface of the piston.

12. The brake apparatus of claim 1, wherein the driving device comprises:
a wedge link connected to a brake wedge of the wedge unit so as to obliquely move the brake wedge; and
a motor moving the wedge link.
